(19) United States
(12) Patent Application Publication
(10) Pub. No.: US 2023/0206597 A1
(43) Pub. Date: Jun. 29, 2023

(54) FACILITATING COMPARING (THEN, NOW, COMPARE - THENCOMP) PHOTO AND / OR VIDEO FOR VIEWING AND SHARING OUTCOME / PROVIDE INFORMATION

(71) Applicants: Smart Ocholi, Portland, OR (US); Mary Ocholi, Portland, OR (US)

(72) Inventors: Smart Ocholi, Portland, OR (US); Mary Ocholi, Portland, OR (US)

(21) Appl. No.: 17/563,041

(22) Filed: Dec. 28, 2021

(51) Int. Cl. G06V 10/74; G06V 10/75; G06F 16/58; G06F 16/583; G06F 16/783; G06F 16/78

(52) U.S. Cl. CPC G06V 10/761; G06V 10/75; G06F 16/5866; G06F 16/583; G06F 16/783; G06F 16/7867

(57) ABSTRACT

Embodiments generally relate to facilitating photo and/or video comparing and sharing of any new post(s) or difference(s) of a thing, person(s), or place among users of the Internet (e.g., a social network system, etc.), gathering(s), or other form(s) of activity, function, and/or particularly related interests, hence, the Then-Now-Compare (TheNComp) aspect of the photos, videos, and/or other related contributions.

### FIELD

Embodiments generally relate to facilitating photo and/or video viewing, comparing, and sharing among users of the Internet (e.g., a social network system, etc.), gathering, or other form of activity, function, and/or particularly related interests.

### BACKGROUND

People, places, and things in our environment either remain the same or continue to change over time. People have been able to have either take photos or videos as time progresses. This makes people to want to go back to such places, things to observe them for what they are, either remain the same or have changed. As a result, is the possibility that they can share these photos or videos for comparison. In one embodiment, a method includes a user taking a photo and/or video of a particular thing, place, or person and then sharing as a new post or comparison to another older photo and/or video of same, or close, dating back for a certain period with other user(s)/guest(s). The method also includes asking other user(s)/guest(s) in the location, in contact with, and/or possession of a thing, place, or person(s) to take a photo and/or video and post it for them to see, compare, and/or share with other user(s)/guest(s).

### SUMMARY

Embodiments generally relate to facilitating photo and/or video comparing and/or sharing either as new or requested post(s) for analyses or comparing purposes among users of the Internet (e.g., a social network system, etc.), gathering(s), or other form(s) of activity, function, and/or particularly related interests, hence, the Then-Now-Compare (TheNComp) aspect of the photos, videos, and/or other related contributions. In one embodiment, a method includes a user or guest taking a photo and/or video of a particular thing, place, or person(s) and then sharing for record to be viewed as a new post and/or compared to another existing and/or older photo and/or video of same, or close to, dating back for a certain period with other users/guests. The method also includes asking other user(s), or guests, in the location, in contact with, and/or possession of something, in a place, or a particular person(s) to take a photo and/or video and post it for them to see, compare, and/or share with other users/guests. It can also use location of person(s) and/or key words (postings with location and/or title of thing, place, person, food, event/activity, and/or other related recognizing features related to postings, etc.).

With further regard to the method, the posting and/or notification are based on member or guest actions dependent on the Internet (e.g., a social network system, etc.) connections, gathering(s), and/or other form(s) of activity, function, and/or particularly related interests. In one embodiment, the response to submission(s) includes identifying one or more certain keyword(s) submitted by one or more user(s) or guest(s), and matching the one or more identified keyword(s) to what was posted or requested by the user(s) either on the thencomp.com site and/or are socially connected to the user on the Internet (e.g., a social network system, etc.), gathering(s), and/or other form(s) of activity, function, and/or particularly related interests. In one embodiment, the method also includes sending the information/indication to the user(s) where they request notification. In one embodiment, the method also includes sending to the user(s)/requester(s) a prompt to respond to the submission/post with level of satisfaction. In one embodiment, the method also includes requesting the user to indicate if the post met their expectation, how close it was to their expectation, and/or anything else/feedback they would like to provide to the poster/audience. In one embodiment, the method also includes enabling the user/requester to associate identifying similarity and/or differences, etc. In one embodiment, the method also includes enabling the user(s) to help verify the validity, accuracy, and/or correctness of post by the user(s)/guest(s).

In another embodiment, a method includes recognizing one or more post(s) by a user(s), where the recognition is based at least in part on what other Internet (e.g., a social network system, etc.) connections, gathering(s), and/or other form(s) of activity, function, and/or particularly related might be interested in and/or indicated interest in. The method also includes enabling the user to associate identifying labels with recognized posts by selecting the post(s) from a list and sharing with others through the Internet (e.g., a social network system, etc.), gathering(s), or other form(s) of activity, function, and/or particularly related and posting/sending a copy of the photo and/or video to at least one or more user(s). The method also includes sending, to at least one user with indicated possible interest and/or request for the post. In response to an indication that at least one or more person(s) is interested or satisfied with the shared post, the method also includes sending to the user(s) a prompt to post/share what they have that is related for others to view or comment on.

With further regard to the system, the sharing is based on members and/or guests in part on the Internet (e.g., a social network system, etc.), gathering(s), or other form(s) of activity, function, and/or particularly related. In one embodiment, the logic when executed is further operable to perform operations including posting new information, commenting on post(s), comparing one or more posting/sending either as a new post or request by one or more people on the site, and comparing to one or more other posts by those who are socially connected to the site/user on the Internet (e.g., a social network system, etc.), gathering(s), or other form(s) of activity, function, and/or particularly related. In one embodiment, the logic when executed is further operable to perform operations including comparing one or more posts, and, where applicable, applying a difference recognition tool to indicate any similarities, changes, and/or differences in the posts. In one embodiment, the logic when executed is further operable to perform operations including sending the indication to the user that placed the request for notification on the post or related one.

### BRIEF DESCRIPTION OF THE DRAWINGS

FIG. 1 illustrates a block diagram of an example network environment TNC, which may be used to implement the embodiments described herein.

FIG. 2 illustrates an example simplified flow diagram for facilitating photo and/or video sharing among users or with guests of the TheNComp social network system.

### DETAILED DESCRIPTION

Embodiments described herein relate to photo and/or video sharing among users of the Internet(e.g., a social network system, etc.), gathering(s), or other form(s) of activity, function, and/or particularly related. In some embodiments, when a user uses any combination of means, such as digital or other means through cameras, smartphones, tablets, notebooks, or any other suitable devices with the capability to capture, share, upload, and/or print information for access and/or sharing with other users or guests. In some embodiments, the users of the Internet (e.g., a social network system, etc.), gathering(s), or other form(s) of activity, function, and/or other particularly related system that can see the new and/or differences in the posts or prints by the member(s), user(s), or guest(s). For example, the user(s) may identify one or more difference(s) in the post(s) of the photo or video. The user(s) and/or attendees may then be either pointed to differences compared to another existing post(s) or be informed of the purpose of the post(s), such as for others to post same thing that is older or newer in the future on the Internet (e.g., a social network system, etc.), gathering(s), or other form(s) of activity, function, and/or particularly related system. In some embodiments, the system, gathering(s), or other form(s) of activity, function, and/or particularly related may provide the user/guest the opportunity to identify or respond to the reason for the photo and/or video post. In some embodiments, the user or guest on the Internet (e.g., a social network system, etc.), gathering(s), or other form(s) of activity, function, and/or other particularly related system may volunteer, opt, and/or consider the method(s) respond right away or at a future day/time.

The network system, gathering(s), and/or other form(s) of activity, function, and/or particularly related setup will be used as avenue to notify the user or member of the photo and/or video either based on request(s) or desire/need to share. In some embodiments, the poster or sharer of the photo and/or video may need to directly notify requester or other members of the photo and/or video by available means possible. The system, gathering(s), or other form(s) of activity, function, and/or other particularly related then receives from the requester of the photo and/or video provide feedback and/or indication of whether the post meets their request. The system, gathering(s), or other form(s) of activity, function, and/or other particularly related then considers the response for user feedback to the photo and/or video to either provide response(s) or perform necessary actions on the post.

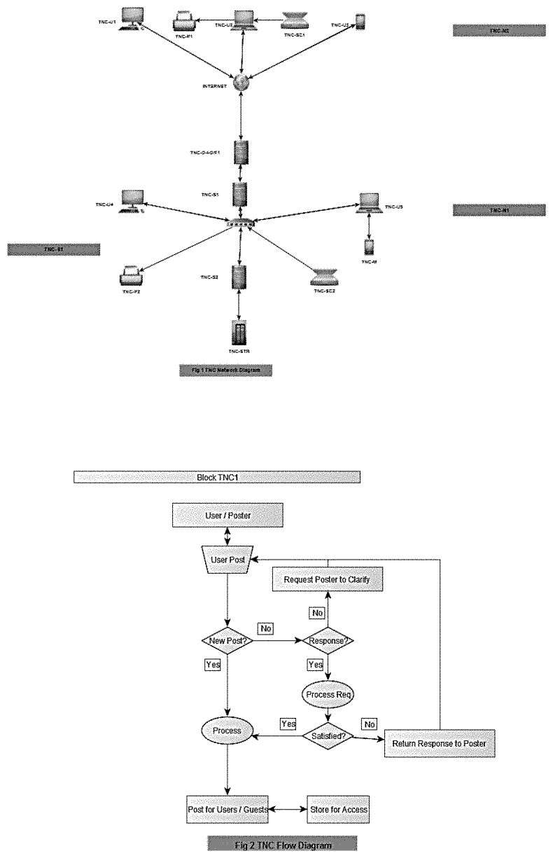

FIG. 1 illustrates a block diagram of an example network environment TNC, which may be used to implement the embodiments described herein. In one embodiment, network environment TNC-N1 includes a system TNC-S1, which includes a server device TNC-S2 and an Internet or social network facing Interface TNC-D-I-D/F1. The term system TNC-S1 and phrase “social network system” may be used interchangeably. Network environment TNC-N1 also includes devices TNC-U4, TNC-U5, TNC-P2, TNC-M, TNC-SC2 and TNC-STR, which may communicate with each other via system TNC-S1 and a network TNC-N2 comprised of other components/devices TNC-U1, TNC-U2, TNC-P1, TNC-U3, TNC-SC1.

For ease of illustration, FIG. 1 shows one block of TNC-N1 for each of system TNC-S1, server device TNC-S2, and an Internet or social network facing Interface TNC-D-I-D/F1, and shows four blocks for client devices TNC-U4, TNC-U5, TNC-P2, TNC-M, TNC-SC2 and TNC-STR. Blocks TNC-S1, TNC-S2, and an Internet or social network facing Interface TNC-D-I-D/F1 may represent multiple systems, server devices, and others that interact with social network databases. Also, there may be any number of client devices. In other embodiments, network environment TNC-N1 may not have all the components shown and/or may have other elements including other types of elements instead of, or in addition to, those shown herein.

In various embodiments, users TNC-U1, TNC-U2, TNC-U3, TNC-U4, and TNC-U5 may take photos and/or videos as well as receive photos and/or videos for viewing and/or approval using respective client devices TNC-U1, TNC-U2, TNC-U3, TNC-U4, TNC-U5, TNC-M, TNC-SC1, and TNC-SC2. Various hardware and software components used to implement embodiments described herein may reside on client devices TNC-U1, TNC-U2, TNC-U3, TNC-U4, TNC-U5, TNC-M, TNC-SC1, and TNC-SC2, and client devices TNC-U1, TNC-U2, TNC-U3, TNC-U4, TNC-U5, TNC-M, TNC-SC1, and TNC-SC2 may be any combination of digital or other form of cameras, smartphones, tablets, laptops, notebooks, printers, scanners, or any other suitable devices with the capability to take pictures, videos, share, upload, and/or print information for other users or guests.

As described in various embodiments herein, users TNC-U1, TNC-U2, TNC-U3, TNC-U4, and TNC-U5 may represent members/individuals of a group participating in an event, photo and/or video, etc. In some embodiments, everyone in the gathering, membership, or guest may participation photo and/or video sharing and may be registered to the photo, video, and/or other related sharing service/the Internet (e.g., a social network system, etc.) of TheNComp. Each member or guest may also be socially connected to others on the Internet (e.g., a social network system, etc.).

FIG. 2 illustrates an example simplified flow diagram for facilitating photo and/or video sharing among users or with guests of the TheNComp social network system. Referring to both FIG. 1 and FIG. 2, a method is initiated in Block TNC1, where system TNC-S1 receives a photo and/or video captured by a user or guest. In various embodiments, the user or guest may capture the photo and/or video using any suitable device such as a camera, smartphone, tablet, etc. In various embodiments, such a device can connect to the Internet (or through other means) after taking the photo and/or video. System TNC-S1 may receive the photo and/or video being uploaded (e.g., to the TheNCompsocial network photo and/or video sharing service), and then as either new post or may be compared to another related photo and/or video.

In Block TNC1, system TNC-S1 recognizes one or more posting of a photo and/or video captured and posted by a user. As described in more detail below, system TNC-S1 may apply a comparison or accept what the poster presents in the photo and/or video as the difference. In various embodiments, system TNC-S1 enables users of the TheNComp social network system to specify the difference in information, which may include system TNC-S1 using the photos or videos to present the information in identifying the difference in photos or videos. For example, system TNC-S1 may provide users or guests with one or multiple notifications of information about posts. For example, for activities with regards to notifying and/or requesting information associated with certain posting of photos or videos. The notifications may be implemented in a variety of ways. For example, system TNC-S1 may send messages to the users or guests. In one embodiment, system TNC-S1 enables users or guests of the TheNComp social network to request postings of photos or videos related to specific or general topics.

In some embodiments, the posting of photos and videos is based at least in part on social TheNCompnetwork, physical gatherings, and other related connections. For example, in some embodiments, system TNC-S1 may identify post(s) by users. System TNC-S1 may then make these available to users or guests on the TheNComp network system. In some embodiments, system TNC-S1 may notify users or guests on TheNComp that may have requested such, based on certain parameters such as keywords. Matching posts to user or guest requests based on TheNComp network connection avoids system TNC-S1 needing to do a global broadcast of posts to everyone in the TheNComp network. In some embodiments, system TNC-S1 may, if needed, still perform a global broadcast or presentation of the post to users or guests in the TheNComp network who did not request notification for the post.

In some embodiments, for other features in the photo and/or video not under consideration, the user(s) or guest(s) may draw attention to such on the TheNComp network system. For example, in some embodiments, system TNC-S1 may display the photo and/or video to the users or guests. System TNC-S1 may then send a message to the poster about the features identified in the photo or video. This also allows the photo and/or video posting action to be delivered to anyone that requested such, which reduces the wide notification by the user who posted the photo or video. System TNC-S1 may also enable the user to respond with satisfactory level, if needed. In some embodiments, system TNC-S1 enables the user to associate the post with their own TheNComp network post or request. In some embodiments, system TNC-S1 enables the user who posted the photo and/or video as well as recipients of the notification of photo and/or video posting to point to or identify if any other features outside of what are interested in that appeared in the post to TheNComp network. In some embodiments, a given user who requests photo(s) or video(s) for a particular topic, place, people, or thing may be prompted to provide additional information (e.g., events, famous or historical, etc.) in order to have others post the photo and/or video for that user or general view. System TNC-S1 may then use the information to send subsequent photos or videos that user or general viewer.

In some embodiments, postings to system TNC-S1 may be determined to capture other aspects of interest besides the focus that users or guest might bring to attention or desire/request more about. For example, a certain portion in the background or any other part of the photo and/or video posted to system TNC-S1, where users or guests may determine that some other contents of the post stand out or appear to be different and worth focusing on. In some embodiments, system TNC-S1 may be used to contact the poster for more information about the parts that is drawing the interest or if it is to be ignored if not part of what was intended for audience. In various embodiments, system TNC-S1 is used to immediately send message out to the poster of photo and/or video to follow on for further action or not, e.g., retake another photo or video, if necessary.

In some embodiments, system TNC-S1 may utilize an existing user service to automatically make the photo and/or video posting available to each user that requested such action. If a given user has a smartphone (or any other suitable device for receiving and view photos or videos), that user may nearly instantaneously view the photo and/or video post. In some embodiments, in order to send a notification of the photo and/or video posting to a given user that requested such, system TNC-S1 may determine or locate a device associated with the given user in the list, and then send the notification the photo and/or video posting to that device. In some embodiments, system TNC-S1 may utilize user profile information such as a user ID, phone number, email address, etc. associated with a given user with the request(s) to notify of the photo and/or video posting.

The recipients of the notification about the photo and/or video post may then say if they post met their request/expectations or not. This also enables the user or guest to confirm the photo and/or video post and share with others. In some embodiments, system TNC-S1 may send out a notification(which may be turned “on” by default) such that the user who requests notification of the photo and/or video post will be able to verify the post meeting request or expectation. If the user that requested the post is not satisfied, they can place the request again with more details as to where the post didn't meet their request or expectations for the post.

In some embodiments, system TNC-S1 may prompt the user posting the photo and/or video whether to share the photo and/or video with other users or guests. Also, if the user posts the photo and/or video with the goal to reach the general community, system TNC-S1 may enable other user(e.g., owner of an account) to approve or disapprove the photo before anyone else looks at it.

In block TNC1, system TNC-S1 receives from a user with an account a photo and/or video post, an action that could be a post not related to any specifics, an update, or in response to another request from a user or guest. In response, a user could express their level of satisfaction with the photo and/or video post. In some embodiments, system TNC-S1 sends a notification to the user about the post. Embodiments described herein render such posting of photo and video notification for new, update, or response to a request for level of satisfaction as account holders or guests using applicable devices (e.g., camera, smartphone, tablet, laptop, desktop, etc.).

In some embodiments, system TNC-S1 may apply various policies regarding a given photo and/or video post. For example, in some embodiments, if a user is not satisfied with a response post, system TNC-S1 may automatically prompt the user who posted the photo and/or video to post another photo or video. In some embodiments, a user who indicated low level of satisfaction in the post may still request to keep the photo and/or video even though another photo and/or video may be posted. In some embodiments, a low level of satisfaction of a photo and/or video post may cause system TNC-S1 to prevent the other users or guests from viewing the photo and/or video posted with low level of satisfaction or may otherwise delete the photo and/or video. Various policies are possible, depending on the implementations.

Although the steps, operations, or computations may be presented in a specific order, the order maybe changed in the embodiments. Other orderings of the steps are possible, depending on the implementation. In some embodiments, multiple steps shown as sequential in this specification maybe performed at the same time.

While system TNC-S1 is described as performing the steps as described in the embodiments herein, any suitable component or combination of components of system TNC-S1 or any suitable processor or processors associated with system TNC-S1 may perform the steps described.

In various embodiments, system TNC-S1 may utilize a variety of comparison tools to recognize similarities or differences in photos and/or videos. Such comparison tools may be integral to system TNC-S1. System TNC-S1 may also access comparison tools provided by software that is external to system TNC-S1 and that system TNC-S1 accesses.

In various embodiments, system TNC-S1 uses the account of users or guests on the TheNComp network system, where each post includes a description of the photo and/or video that is new, update, requested, or general post by a user. The user is known, in that system TNC-S1 has the user's identity information such as the user's name and other profile information. In one embodiment, a post may be, for example, a photo and/or video that the user has uploaded. In one embodiment, a post may be based on a new, updated, or other photo and/or video request from user or guest.

In one embodiment, to consider the posted photo and/or video for meeting the reason for the post, system TNC-S1 may compare the posted photo and/or video to another by other user(s) of the TheNComp network system. For ease of illustration, the comparison of the post is described in some of the example embodiments described herein. These embodiments may also apply to each post of multiple other postings to be compared.

In one embodiment, system TNC-S1 may search posted photos or videos in order to identify any differences or similarities to the other photos and/or videos.

In one embodiment, for a given posted photo and/or video, system TNC-S1 may extract features from the post for analysis, and then compare those features to those of other posts. For example, system TNC-S1 may analyze the relative age, position, size, and/or shape of photo and/or video content such as people, things, and/or any other aspects of interest. In one embodiment, system TNC-S1 may use data gathered from the analysis to match or identify difference(s) of the post to one more other post with matching or similar features or characteristics. In one embodiment, system TNC-S1 may normalize multiple posts, and compress photos and/or video from those posts into a composite representation having information (e.g., matches or differences), and then compare the contents of the photo and/or video to the composite representation for further action.

In some scenarios, the content(s) of the photo and/or video may match or be different to multiple other posts by the same or another user. As such, there would be a high probability that the user associated with the post is the same user or guest associated with the photo and/or video.

In some scenarios, the photo and/or video may be like multiple posts associated with different users. As such, there would be a moderately high yet decreased probability that the user is the same as the original poster. To handle such a situation, system TNC-S1 may use various types of comparison tools to narrow the matches or differences, ideally down to best outcomes that standout.

For example, in one embodiment, to facilitate notification of a post, system TNC-S1 may execute specific request by user(s) or guest(s), which are based on features described. System TNC-S1 may also use general settings for posts, which are based on features that identify values that could be used for comparison. A combination of the response to request and general posting approaches could also be used when comparing the photo and/or video to one or more related.

Other photo and/or video comparison tool may be used. For example, system TNC-S1 may use comparison tool that use one or more of principal component analyzer to accurately find and possibly present the differences in the photos and/or videos posted. It will be appreciated that system TNC-S1 may use other known or later developed analyzing tools, techniques, and/or systems.

In one embodiment, system TNC-S1 may generate an output indicating a likelihood (or probability) that the posted photo and/or video relate to another existing post or meeting a request(s). In one embodiment, the output may be represented as a comparison such as a pointing out of the similarities or differences that exist with the posted photo and/or video. For example, a message may be generated to indicate 100% meeting a request. This could occur, for example, when user requests a post of photos and/or videos and what is posted is identical or nearly identical to the request.

Embodiments described herein provide various benefits. For example, embodiments enable users to immediate post or request photos and/or videos with specifics to be posted. Users or guests may quickly and conveniently receive notifications for the post to indicate if it meets expectation or need more work.

The devices will be made up of computer servers that include processor, an operating system, a memory, and an input/output (I/O) interface. Other parts are social network engine and a media application, which may be stored in memory or on any other suitable storage location or computer-readable medium. The devices perform applicable functions based various instructions needed to implement the embodiments described herein. These components may not be represented in all of the components shown and/or may have other elements including other types of elements instead of, or in addition to, those shown herein.

Although the description has been described with respect to embodiments thereof, these embodiments are merely illustrative, and not restrictive. Concepts illustrated in the examples may be applied to other examples and embodiments.

Note that the functional blocks, methods, devices, and systems described in the present disclosure may be integrated or divided into different combinations of systems, devices, and functional blocks as would be known to those skilled in the art.

Any suitable programming languages and programming techniques may be used to implement the routines of embodiments. Different programming techniques may be employed such as procedural or object-oriented. The routines may execute on a single processing device or multiple processors. Although the steps, operations, or computations may be presented in a specific order, the order maybe changed in different embodiments. In some embodiments, multiple steps shown as sequential in this specification may be performed at the same time.

A “processor” includes any suitable hardware and/or software system, mechanism or component that processes data, signals or other information. A processor may include a system with a general-purpose central processing unit, multiple processing units, dedicated circuitry for achieving functionality, or other systems. Processing need not be limited to a geographic location or have temporal limitations. For example, a processor may perform its functions in “real-time,” “offline,” in a “batch mode,” etc. Portions of processing may be performed at different times and at different locations, by different (or the same) processing systems. A computer may be any processor in communication with a memory. The memory may be any suitable processor-readable storage medium, such as random-access memory (RAM), read-only memory (ROM), magnetic or optical disk, or other tangible media suitable for storing instructions for execution by the processor.

1. A computer-implemented method, the method comprising:
User(s) posts photo(s) and/or video(s), which is either new or compared to one or more other same, similar, and/or closely related photo(s) or video(s) of a thing, place, or person(s) posted by user(s) to indicate change(s) over a period of time; user(s) are able to have other user(s) on a thing, place, or person(s) they have a photo and/or video of such to help them see difference(s) that might have taken place over or within certain period, if any.

2. The method of claim 1, wherein the user(s) is/are registered members or visiting guest(s), also with potential or opportunity/intention to join.

3. The method of claim 1, wherein the user(s) send photo(s) and/or video(s) that are taken from a position, direction, or proximity as close as possible, circumstances allowing, to the original photo and/or video.

4. The method of claim 1, wherein the users send photo(s) and/or video(s) that are taken from a position, direction, or proximity as close as possible, circumstances allowing, to the original photo(s) and/or video(s) showing difference(s), if any.

5. The method of claim 1, further comprising of receiving other photo(s) and/or video(s) that are taken by the user(s), while observing any existing and/or associated rules/laws, policies, regulations, etc.
